(19) United States
(12) Patent Application Publication
(10) Pub. No.: US 2017/0080697 A1
(43) Pub. Date: Mar. 23, 2017

(54) ADHESIVE SHEET AND ADHESIVE-SHEET APPLICATION METHOD

(71) Applicant: NITTO DENKO CORPORATION, Osaka (JP)

(72) Inventors: Hiroshi WADA, Osaka (JP); Yuki TSUBAKI, Osaka (JP); Takahisa KUSUURA, Tokyo (JP); Takahiro YASUTOMI, Kanagawa (JP)

(73) Assignee: NITTO DENKO CORPORATION, Osaka (JP)

(21) Appl. No.: 15/272,746

(22) Filed: Sep. 22, 2016

(30) Foreign Application Priority Data
Sep. 23, 2015 (JP) 2015-186180

(51) Int. Cl. B32B 38/00; B32B 37/12; C09J 133/02; C09J 5/02; C09J 7/02; B32B 3/30; C09J 9/00

(52) U.S. Cl. CPC B32B 38/0008; B32B 3/30; B32B 38/0036; B32B 37/12; C09J 9/00; C09J 5/02; C09J 7/0246; C09J 133/02; B32B 2405/00; C09J 2201/606; C09J 2201/622; C09J 2201/28

(57) ABSTRACT

The present invention relates to an adhesive sheet which is to be applied to an adherend, in which the adhesive sheet includes an adhesive layer containing a volume change substance that expands in volume upon reception of an external stimulus and thereafter contracts in volume with a lapse of time, and the adhesive sheet is configured so that a plurality of surface irregularities are formed on at least one surface of the adhesive layer as a result of the volume expansion of the volume change substance and that channel areas for air bubble expelling are capable of being formed between said one surface of the adhesive layer and the adherend based on the surface irregularities.

### FIELD OF THE INVENTION

The present invention relates to an adhesive sheet and an adhesive-sheet application method.

### BACKGROUND OF THE INVENTION

An adhesive sheet is a sheet-shaped object to which an adhesive has been applied beforehand and, hence, has an advantage in that the adhesive sheet is free from the trouble of applying an adhesive each time a sheet-shaped object is applied to an adherend. Such adhesive sheets are used in various applications.

However, general adhesive sheets have had a problem in that since the adhesive sheets each have a flat adhesive layer having an even thickness, there are cases where air bubbles are trapped when applying the adhesive sheet to an adherend, if a sufficient care is not taken in the application, and it is difficult to expel the air bubbles which have been trapped.

Known as an adhesive sheet for preventing such air bubble trapping is, for example, an adhesive sheet in which fine beads have been dispersedly disposed near the surface of the adhesive layer to form, on the surface of the adhesive layer, recesses and protrusions due to the fine beads. This adhesive sheet is intended so that when applying the adhesive sheet to an adherend, channel areas for air bubble expelling (the gap between the adhesive layer and the adherend) which are based on the recesses and protrusions are formed between the adhesive layer and the adherend. In this adhesive sheet, the channel areas formed upon application of the adhesive layer to an adherend gradually disappear due to the flowability of the adhesive layer and it is possible to expel the trapped air bubbles with the disappearance of the channel areas. In addition, the increased area of contact with the adherend brings about high adhesive strength.

### SUMMARY OF THE INVENTION

The adhesive sheet including fine beads described above exhibits the function of effectively expelling air bubbles, so long as the fine beads are present near the surface of the adhesive layer at the time when the adhesive sheet is applied to an adherend. However, there has been a problem in that the fine beads which were dispersedly disposed in the surface of the adhesive layer are gradually buried in the adhesive layer with the lapse of time from the production to just before application and, as a result, when actually applying this adhesive sheet to an adherend, it has become impossible to form channel areas which are based on recesses and protrusions and are capable of sufficiently exhibiting the function of expelling air bubbles.

An object of the present invention, which has been achieved in order to overcome the problem, is to provide an adhesive sheet which can sufficiently exhibit the function of expelling air bubbles, at the time of application to an adherend. Another object of the present invention is to provide a method for applying such an adhesive sheet.

The above-mentioned object of the present invention is achieved by an adhesive sheet which is to be applied to an adherend, in which the adhesive sheet includes an adhesive layer containing a volume change substance that expands in volume upon reception of an external stimulus and thereafter contracts in volume with a lapse of time, and the adhesive sheet is configured so that a plurality of surface irregularities are formed on at least one surface of the adhesive layer as a result of the volume expansion of the volume change substance and that channel areas for air bubble expelling are capable of being formed between the one surface of the adhesive layer and the adherend based on the surface irregularities.

In this adhesive sheet, it is preferable that the volume change substance is microcapsules containing a phase change substance.

It is preferable that the microcapsules containing a phase change substance are heat-expandable microcapsules or photoexpandable microcapsules.

It is preferable that the adhesive layer has a pair of opposed side-edge portions, and the channel areas are configured so as to communicate between the pair of opposed side-edge portions.

Additionally, the above-mentioned object of the present invention is achieved by an adhesive-sheet application method for applying an adhesive sheet to an adherend, the method including: a surface irregularity formation step in which an external stimulus is given to an adhesive sheet including an adhesive layer containing a volume change substance that expands in volume upon reception of an external stimulus and thereafter contracts in volume with a lapse of time, thereby causing the volume change substance to expand in volume and forming a plurality of surface irregularities on one surface of the adhesive layer; an application step in which the one surface of the adhesive layer is applied to an adherend while forming, between the one surface of the adhesive layer and the adherend, channel areas for air bubble expelling which are based on the surface irregularities; and an adhesiveness enhancement step in which an area of contact between the one surface of the adhesive layer and the adherend is increased while expelling air bubbles simultaneously with diminishing the channel areas which are based on the surface irregularities, at least along with volume contraction with time of the volume change substance which has expanded in volume.

According to the present invention, it is possible to provide an adhesive sheet which can sufficiently exhibit the function of expelling air bubbles, at the time of application to an adherend. It is also possible to provide a method for applying such an adhesive sheet.

### BRIEF DESCRIPTION OF THE DRAWING

FIG. 1 is a diagrammatic cross-sectional view which illustrates the configuration of an adhesive sheet according to a first embodiment of the present invention.

FIG. 2 is a view for illustrating a method for applying the adhesive sheet according to the first embodiment of the present invention.

FIG. 3 is a view for illustrating the method for applying the adhesive sheet according to the first embodiment of the present invention.

FIG. 4 is a view for illustrating the method for applying the adhesive sheet according to the first embodiment of the present invention.

FIG. 5 is a view for illustrating the method for applying the adhesive sheet according to the first embodiment of the present invention.

FIG. 6 is an enlarged view of a main part of FIG. 5.

FIG. 7 is a view for illustrating the method for applying the adhesive sheet according to the first embodiment of the present invention.

FIG. 8 is an enlarged diagrammatic cross-sectional view which illustrates the configuration of a main part of the adhesive sheet according to the first embodiment of the present invention.

FIG. 9 is a diagrammatic cross-sectional view which illustrates the configuration of an adhesive sheet according to a second embodiment of the present invention.

FIG. 10 is a view for illustrating a method for applying the adhesive sheet according to the second embodiment of the present invention.

FIG. 11 is a view for illustrating the method for applying the adhesive sheet according to the second embodiment of the present invention.

FIG. 12 is a view for illustrating the method for applying the adhesive sheet according to the second embodiment of the present invention.

FIG. 13 is a view for illustrating the method for applying the adhesive sheet according to the second embodiment of the present invention.

FIG. 14 is an enlarged view of a main part of FIG. 13.

FIG. 15 is a view for illustrating the method for applying the adhesive sheet according to the second embodiment of the present invention.

FIGS. 16A to 16C are diagrammatic plan views which show the configurations of modifications of the adhesive sheet according to the present invention.

FIGS. 17A and 17B are views for illustrating modifications of the adhesive sheet according to the present invention.

FIG. 18 is a view for illustrating a modification of the adhesive sheet according to the present invention.

### DETAILED DESCRIPTION OF THE INVENTION

Adhesive sheets according to a first embodiment and a second embodiment of the present invention are explained below while referring to accompanying drawings.

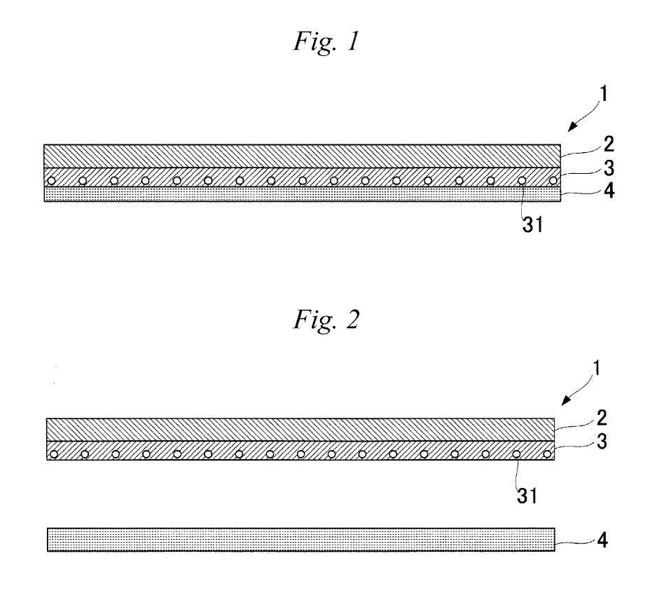

Each drawing has been partly enlarged or reduced for the purpose of easy understanding of the configuration. First, the adhesive sheet according to a first embodiment of the present invention is explained. FIG. 1 is a diagrammatic cross-sectional view which illustrates the configuration of the adhesive sheet according to the first embodiment of the present invention. The adhesive sheet 1 according to the first embodiment is an adhesive sheet 1 to be applied to an adherend, and includes a substrate 2, an adhesive layer 3 which contains a volume change substance 31, and a release liner 4, as shown in FIG. 1.

As the substrate 2, use can be made of one which is generally used as the substrates of adhesive sheets. Examples of the material constituting the substrate 2 include resinous materials (e.g., sheet-shaped or net-shaped materials, woven fabric, nonwoven fabric, and foamed sheets), paper, and metals. The substrate 2 may be constituted of a single layer, or may be composed of multiple layers constituted of the same or different materials. Examples of resins for constituting the substrate 2 include polyesters, polyolefins, ethylene/vinyl acetate copolymers, ethylene/(meth)acrylic acid copolymers, ethylene/(meth)acrylic ester copolymers, ethylene/butene copolymers, ethylene/hexene copolymers, polyurethanes, polyetherketones, poly(vinyl alcohol), poly(vinylidene chloride), poly(vinyl chloride), vinyl chloride/vinyl acetate copolymers, poly(vinyl acetate), polyamides, polyimides, cellulosic resins, fluororesins, silicone resins, polyethers, polystyrene-based resins (e.g., polystyrene), polycarbonates, polyethersulfones, and crosslinked forms of these resins.

The thickness of the substrate 2 can be suitably set. However, the thickness thereof is preferably 0.5 μm to 1,000 μm, and it is more preferred to set the thickness thereof at a value in the range of 5 μm to 500 μm. Any appropriate surface treatment may be given to the substrate 2 in accordance with purposes. Examples of the surface treatment include a treatment with chromic acid, exposure to ozone, exposure to a flame, exposure to high-voltage electric shocks, treatment with ionizing radiation, matting, corona discharge treatment, priming, and crosslinking.

The adhesive layer 3 containing a volume change substance 31 is disposed on one surface of the substrate 2. This adhesive layer 3 is configured so that a plurality of fine surface irregularities 6 are formed on the surface of the adhesive layer 3 upon reception of an external stimulus. The adhesive as the main component of this adhesive layer 3 can be selected from various adhesives which are generally used as adhesive layers of adhesive sheets, such as pressure-sensitive adhesives, thermoplastic adhesives, and thermosetting adhesives.

The adhesive layer 3 can be a pressure-sensitive adhesive layer formed from either an aqueous pressure-sensitive adhesive composition or a solvent-based pressure-sensitive adhesive composition. The term “aqueous pressure-sensitive adhesive composition” means a pressure-sensitive adhesive composition configured of a medium including water as the main component (aqueous medium) and a pressure-sensitive adhesive (ingredient for pressure-sensitive-adhesive layer formation) contained in the medium. This conception of aqueous pressure-sensitive adhesive composition can include compositions which are called aqueous dispersion type pressure-sensitive adhesive compositions (compositions of the type configured of water and a pressure-sensitive adhesive dispersed therein), aqueous solution type pressure-sensitive adhesive compositions (compositions of the type configured of water and a pressure-sensitive adhesive dissolved therein), and the like. Meanwhile, the term “solvent-based pressure-sensitive adhesive composition” means a pressure-sensitive adhesive composition configured of an organic solvent and a pressure-sensitive adhesive contained therein.

In the techniques disclosed herein, the kind of the pressure-sensitive adhesive included in the adhesive layer 3 is not particularly limited. For example, the pressure-sensitive adhesive can be one which includes, as one or more base polymers, one or more polymers selected from among various polymers capable of functioning as pressure-sensitive adhesive ingredients (polymers having pressure-sensitive adhesiveness), such as acrylic polymers, polyesters, urethane polymers, polyethers, rubbers, silicones, polyamides, and fluoropolymers. In a preferred mode, the main component of the adhesive layer 3 is an acrylic pressure-sensitive adhesive. The techniques disclosed herein can be advantageously practiced in the form of a double-faced pressure-sensitive adhesive sheet having pressure-sensitive adhesive layers each constituted substantially of an acrylic pressure-sensitive adhesive. The pressure-sensitive adhesive layers typically are pressure-sensitive adhesive layers formed from a pressure-sensitive adhesive composition including a polymer having pressure-sensitive adhesiveness (preferably, an acrylic polymer).

The term “acrylic pressure-sensitive adhesive” herein means a pressure-sensitive adhesive which includes an acrylic polymer as a base polymer (a main component of the polymer component(s); i.e., a component accounting for more than 50% by mass of the polymer component(s)). The term “acrylic polymer” means a polymer for which one or more monomers each having at least one (meth)acryloyl group in one molecule thereof (hereinafter, these monomers are often referred to as “acrylic monomers”) were used as a main constituent monomer component (a main component of all the monomers; i.e., a component accounting for more than 50% by mass of all the monomers for constituting the acrylic polymer). In this specification, the term “(meth)acryloyl group” inclusively means an acryloyl group and a methacryloyl group. Likewise, “(meth)acrylate” inclusively means an acrylate and a methacrylate.

The acrylic polymer typically is a polymer produced using one or more alkyl (meth)acrylates as a main constituent monomer component. For example, compounds represented by the following formula (1) are suitably used as the alkyl (meth)acrylates.

CH₂═C(R¹)COOR² (1)

R¹ in formula (1) is a hydrogen atom or a methyl group. R² is an alkyl group having 1-20 carbon atoms. Alkyl (meth)acrylates in which R² is an alkyl group having 2-14 carbon atoms (hereinafter, this range of the number of carbon atoms is often referred to as C₂₋₁₄) are preferred since a pressure-sensitive adhesive having excellent pressure-sensitive adhesive performance is apt to be obtained with such alkyl (meth)acrylates. Examples of the C₂₋₁₄ alkyl group include ethyl, propyl, isopropyl, n-butyl, isobutyl, s-butyl, t-butyl, n-pentyl, isoamyl, neopentyl, n-hexyl, n-heptyl, n-octyl, isooctyl, 2-ethylhexyl, n-nonyl, isononyl, n-decyl, isodecyl, n-undecyl, n-dodecyl, n-tridecyl, and n-tetradecyl.

In a preferred mode, about 50% by mass or more (typically 50-99.9% by mass), more preferably 70% by mass or more (typically 70-99.9% by mass), and, for example, about 85% by mass or more (typically 85-99.9% by mass), of all the monomers to be used for synthesizing the acrylic polymer is accounted for by one or more monomers selected from among alkyl (meth)acrylates represented by formula (1) in which R² is a C₂₋₁₄ alkyl (more preferably C₄₋₁₀-alkyl (meth)acrylates; especially preferably, butyl acrylate and/or 2-ethylhexyl acrylate). Such a monomer composition is preferred because an acrylic polymer obtained therefrom is apt to give a pressure-sensitive adhesive which shows satisfactory pressure-sensitive adhesive properties.

In the techniques disclosed herein, acrylic polymers in which an acrylic monomer having a hydroxyl group (—OH) has been copolymerized can be preferably used. Examples of the acrylic monomer having a hydroxyl group include 2-hydroxyethyl (meth)acrylate, 2-hydroxypropyl (meth)acrylate, 3-hydorxypropyl (meth)acrylate, 2-hydroxybutyl (meth)acrylate, 4-hyroxybutyl (meth)acrylate, 2-hydroxyhexyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, (4-hydroxymethylcyclohexyl)methyl acrylate, polypropylene glycol mono(meth)acrylate, N-hydroxyethyl(meth)acrylamide, and N-hydroxypropyl(meth)acrylamide. One of such hydroxyl-containing acrylic monomers may be used alone, or two or more thereof may be used in combination.

Such hydroxyl-containing acrylic monomers are preferred because an acrylic polymer in which such a monomer has been copolymerized is apt to give a pressure-sensitive adhesive which has an excellent balance between pressure-sensitive adhesive force and cohesive force and further has excellent re-releasability. Especially preferred examples of the hydroxyl-containing acrylic monomer include hydroxyalkyl (meth)acrylates such as 2-hydroxyethyl (meth)acrylate, 2-hydroxypropyl (meth)acrylate, 3-hydroxypropyl (meth)acrylate, 2-hydroxybutyl (meth)acrylate, and 4-hydroxybutyl (meth)acrylate. For example, a hydroxyalkyl (meth)acrylate in which the alkyl group in the hydroxyalkyl group is a linear group having 2-4 carbon atoms can be preferably used.

It is preferable that such a hydroxyl-containing acrylic monomer is used in an amount in the range of about 0.001-10% by mass based on all the monomers to be used for synthesizing the acrylic polymer. Such use of the hydroxyl-containing acrylic monomer makes it possible to produce a pressure-sensitive adhesive sheet in which the pressure-sensitive adhesive force and the cohesive force are balanced on a higher level. By regulating the use amount of the hydroxyl-containing acrylic monomer to about 0.01-5% by mass (e.g., 0.05-2% by mass), better results can be achieved.

In the acrylic polymer in the techniques disclosed herein, monomers other than those shown above (“other monomers”) may have been copolymerized so long as the effects of the present invention are not considerably impaired. Such monomers can be used, for example, for the purposes of regulating the Tg of the acrylic polymer, regulating the pressure-sensitive adhesive performance (e.g., re-releasability) thereof, etc. Examples of monomers capable of improving the cohesive force and heat resistance of the pressure-sensitive adhesive include monomers containing a sulfonic group, monomers containing a phosphate group, monomers containing a cyano group, vinyl esters, and aromatic vinyl compounds. Meanwhile, examples of monomers capable of introducing a functional group serving as a crosslinking site into the acrylic polymer or of contributing to an improvement in adhesive strength include monomers containing a carboxyl group, monomers containing an acid anhydride group, monomers containing an amide group, monomers containing an amino group, monomers containing an imido group, monomers containing an epoxy group, (meth)acryloylmorpholine, and vinyl ethers.

Examples of the monomers containing a sulfonic group include styrenesulfonic acid, allylsulfonic acid, 2-(meth)acrylamido-2-methylpropanesulfonic acid, (meth)acrylamidopropanesulfonic acid, sulfopropyl (meth)acrylate, (meth)acryloyloxynaphthalenesulfonic acid, and sodium vinylsulfonate. Examples of the monomers containing a phosphate group include 2-hydroxyethyl acryloyl phosphate. Examples of the monomers containing a cyano group include acrylonitrile and methacrylonitrile. Examples of the vinyl esters include vinyl acetate, vinyl propionate, and vinyl laurate. Examples of the aromatic vinyl compounds include styrene, chlorostyrene, chloromethylstyrene, α-methylstyrene, and other substituted styrenes.

Examples of the monomers containing a carboxyl group include acrylic acid, methacrylic acid, carboxyethyl (meth)acrylate, carboxypentyl (meth)acrylate, itaconic acid, maleic acid, fumaric acid, crotonic acid, and isocrotonic acid. Examples of the monomers containing an acid anhydride group include maleic anhydride, itaconic anhydride, and the acid anhydrides of those carboxyl-containing monomers. Examples of the monomers containing an amide group include acrylamide, methacrylamide, diethylacrylamide, N-vinylpyrrolidone, N,N-dimethylacrylamide, N,N-dimethylmethacrylamide, N,N-diethylacrylamide, N,N-diethylmethacrylamide, N,N′-methylenebisacrylamide, N,N-dimethylaminopropylacrylamide, N,N-dimethylaminopropylmethacrylamide, and diacetoneacrylamide. Examples of the monomers containing an amino group include aminoethyl (meth)acrylate, N,N-dimethylaminoethyl (meth)acrylate, and N,N-dimethylaminopropyl (meth)acrylate. Examples of the monomers containing an imide group include cyclohexylmaleimide, isopropylmaleimide, N-cyclohexylmaleimide, and itaconimide. Examples of the monomers containing an epoxy group include glycidyl (meth)acrylate, methylglycidyl (meth)acrylate, and allyl glycidyl ether. Examples of the vinyl ethers include methyl vinyl ether, ethyl vinyl ether, and isobutyl vinyl ether.

One of such “other monomers” may be used alone, or two or more thereof may be used in combination. However, the total content of such other monomers based on all the monomers to be used for synthesizing the acrylic polymer is preferably about 40% by mass or less (typically 0.001-40% by mass), more preferably about 30% by mass or less (typically 0.01-30% by mass, e.g., 0.1-10% by mass). In the case of using a carboxyl-containing monomer as one of the other monomers, the content thereof based on all the monomers can be, for example, 0.1-10% by mass, and an appropriate range thereof is usually 0.5-5% by mass. Meanwhile, in the case of using a vinyl ester (e.g., vinyl acetate) as one of the other monomers, the content thereof based on all the monomers can be, for example, 0.1-20% by mass, and an appropriate range thereof is usually 0.5-10% by mass.

It is desirable that the comonomer composition for the acrylic polymer is designed so that the polymer has a glass transition temperature (Tg) of −15° C. or lower (typically −70° C. to −15° C.). The Tg thereof is preferably −25° C. or lower (e.g., −60° C. to −25° C.), more preferably −40° C. or lower (e.g., −60° C. to −40° C.). In case where the Tg of the acrylic polymer is too high, there can be cases where the pressure-sensitive adhesive containing this acrylic polymer as a base polymer is prone to be reduced in pressure-sensitive adhesive force (e.g., pressure-sensitive adhesive force in low-temperature environments, pressure-sensitive adhesive force in application to rough surfaces, etc.). In case where the Tg of the acrylic polymer is too low, there can be cases where the pressure-sensitive adhesive has reduced adhesiveness to curved surfaces or has reduced re-releasability (which results in, for example, adhesive transfer).

The Tg of the acrylic polymer can be regulated by suitably changing the monomer composition (i.e., the kinds and proportions of the monomers to be used for synthesizing the polymer). The term “Tg of an acrylic polymer” means a value determined using the Fox equation from the Tg of a homopolymer of each of the monomers used for constituting the polymer and from the mass proportions of the monomers (copolymerization ratio by mass). As the Tg of homopolymers, the values shown in a known document are employed

In the techniques disclosed herein, the following values are specifically used as the Tg of homopolymers.

| | | |
|---|---|---|
| 2-Ethylhexyl acrylate | −70° | C. |
| Butyl acrylate | −55° | C. |
| Ethyl acrylate | −22° | C. |
| Methyl acrylate | 8° | C. |
| Methyl methacrylate | 105° | C. |
| Cyclohexyl methacrylate | 66° | C. |
| Vinyl acetate | 32° | C. |
| Styrene | 100° | C. |
| Acrylic acid | 106° | C. |
| Methacrylic acid | 130° | C. |

With respect to the Tg of homopolymers other than those shown above as examples, the values given in “Polymer Handbook” (3rd ed., John Wiley & Sons, Inc., 1989) are used. [0034]

In the case of a monomer, the Tg of a homopolymer of which is not given in “Polymer Handbook” (3rd ed., John Wiley & Sons, Inc., 1989), the value obtained by the following measuring method is used (see JP-A-2007-51271). Specifically, 100 parts by mass of the monomer, 0.2 parts by mass of azobisisobutyronitrile, and 200 parts by mass of ethyl acetate as a polymerization solvent are introduced into a reactor equipped with a thermometer, stirrer, nitrogen introduction tube, and reflux condenser, and the contents are stirred for 1 hour while passing nitrogen gas therethrough. The oxygen present in the polymerization system is thus removed, and the contents are then heated to 63° C. to react the monomer for 10 hours. Subsequently, the reaction mixture is cooled to room temperature to obtain a homopolymer solution having a solid concentration of 33% by mass. This homopolymer solution is then applied to a release liner by casting and dried to produce a test sample (sheet-shaped homopolymer) having a thickness of about 2 mm. A disk-shaped specimen having a diameter of 7.9 mm is punched out from the test sample, sandwiched between parallel plates, and examined for viscoelasticity using a viscoelastometer (trade name “ARES”, manufactured by Rheometric Inc.) in the shear mode under the conditions of a temperature range of −70 to 150° C. and a heating rate of 5° C./min while giving thereto a shear strain with a frequency of 1 Hz. The temperature corresponding to the tans (loss tangent) peak top is taken as the Tg of the homopolymer.

It is preferable that the pressure-sensitive adhesive in the techniques disclosed herein is designed so that the peak top temperature regarding the shear loss modulus G″ thereof is −10° C. or lower (typically −10° C. to −40° C.). For example, a preferred pressure-sensitive adhesive is one which is designed so that the peak top temperature is −15° C. to −35° C. In this specification, the peak top temperature regarding shear loss modulus G″ can be understood by punching out a disk-shaped specimen having a diameter of 7.9 mm from a sheet-shaped pressure-sensitive adhesive having a thickness of 1 mm, sandwiching the specimen between parallel plates, examining the specimen for the temperature dependence of loss modulus G″ using the viscoelastometer (trade name “ARES”, manufactured by Rheometric Inc.) in the shear mode under the conditions of a temperature range of −70 to 150° C. and a heating rate of 5° C/min while giving thereto a shear strain with a frequency of 1 Hz, and determining the temperature corresponding to the top of a peak of the temperature dependence (i.e., the temperature at which the G″ curve is maximal). The peak top temperature regarding shear loss modulus G″ of the acrylic polymer can be regulated by suitably changing the monomer composition (i.e., the kinds and proportions of the monomers to be used for synthesizing the polymer).

Methods for obtaining an acrylic polymer having such monomer composition are not particularly limited, and various polymerization methods known as techniques for synthesizing acrylic polymers, such as solution polymerization, emulsion polymerization, bulk polymerization, and suspension polymerization, can be suitably employed. For example, solution polymerization can be preferably used. As a method for feeding monomers when performing solution polymerization, use can be suitably made of an en bloc monomer introduction method, in which all the starting monomers are fed at a time, a continuous-feeding (dropping) method, installment-feeding (dropping) method, or the like. A polymerization temperature can be suitably selected in accordance with the kinds of the monomers and solvent used, the kind of the polymerization initiator, etc. For example, the temperature can be about 20-170° C. (typically 40-140° C.).

The solvent to be used for the solution polymerization can be suitably selected from known or common organic solvents. For example, use can be made of any one of the following solvents or a mixed solvent composed of two or more of the following solvents: aromatic compounds (typically aromatic hydrocarbons) such as toluene and xylene; aliphatic or alicyclic hydrocarbons such as ethyl acetate, hexane, cyclohexane, and methylcyclohexane; halogenated alkanes such as 1,2-dichloroethane; lower alcohols (e.g., monohydric alcohols having 1-4 carbon atoms) such as isopropyl alcohol, 1-butanol, sec-butanol, and tert-butanol; ethers such as tert-butyl methyl ether; ketones such as methyl ethyl ketone and acetylacetone; and the like. It is preferred to use an organic solvent (which can be a mixed solvent) having a boiling point of 20-200° C. (more preferably 25-150° C.) at a total pressure of 1 atm.

The initiator to be used in the polymerization can be suitably selected from known or common polymerization initiators in accordance with the kind of the polymerization method. For example, an azo polymerization initiator can be preferably used. Examples of the azo polymerization initiator include 2,2′-azobisisobutyronitrile, 2,2′-azobis(2-methylpropionamidine) disulfate, 2,2′-azobis(2-amidinopropane) dihydrochloride, 2,2′-azobis[2-(5-methyl-2-imidazolin-2-yl)propane]dihydrochloride, 2,2′-azobis(N,N′-dimethyleneisobutylamidine), 2,2′-azobis[N-2-carboxyethyl]-2-methylpropionamidine] hydrate, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-l-carbonitrile), 2,2′-azobis(2,4,4-trimethylpentane), and dimethyl 2,2′-azobis(2-methylpropionate).

Other examples of the polymerization initiator include: persulfates such as potassium persulfate and ammonium persulfate; peroxide initiators such as benzoyl peroxide, t-butyl hydroperoxide, di-t-butyl peroxide, t-butyl peroxybenozate, dicumyl peroxide, 1,1-bis(t-butylperoxy)-3,3,5-trimethylcyclohexane, 1,1-bis(t-butylperoxy)cyclododecane, and hydrogen peroxide; substituted-ethane initiators such as phenyl-substituted ethanes; and aromatic carbonyl compounds. Still other examples of the polymerization initiator include redox initiators each based on a combination of a peroxide and a reducing agent. Examples of the redox initiators include a combination of a peroxide and ascorbic acid (e.g., combination of hydrogen peroxide and ascorbic acid), a combination of a peroxide and an iron(II) salt (e.g., combination of hydrogen peroxide and an iron(II) salt), and a combination of a persulfate and sodium hydrogen sulfite.

One of such polymerization initiators can be used alone, or two or more thereof can be used in combination. The polymerization initiator may be used in an ordinary amount. For example, the use amount thereof can be selected from the range of about 0.005-1 part by mass (typically 0.01-1 part by mass) per 100 parts by mass of all the monomer ingredients.

According to this solution polymerization, a liquid polymerization reaction mixture in the form of a solution of an acrylic polymer in the organic solvent is obtained. This liquid polymerization reaction mixture as such or after having undergone an appropriate post-treatment can be preferably used as the acrylic polymer in the techniques disclosed herein. Typically, the acrylic-polymer-containing solution which has undergone a post-treatment is regulated so as to have an appropriate viscosity (concentration) and then used. Alternatively, use may be made of a solution obtained by synthesizing an acrylic polymer by a polymerization method other than solution polymerization (e.g., emulsion polymerization, photopolymerization, or bulk polymerization) and dissolving the polymer in an organic solvent.

When the acrylic polymer in the techniques disclosed herein has too low a weight-average molecular weight (Mw), there can be cases where the pressure-sensitive adhesive is prone to have insufficient cohesive force to cause adhesive transfer to adherend surfaces or is prone to have reduced adhesiveness to curved surfaces. Meanwhile, when the Mw thereof is too high, there can be cases where the pressure-sensitive adhesive is prone to have reduced pressure-sensitive adhesive force in application to adherends. From the standpoint of balancing pressure-sensitive adhesive performance with re-releasability on a high level, an acrylic polymer having an Mw in the range of 10×10⁴ to 500×10⁴ is preferred. An acrylic polymer having an Mw of 20×10⁴ to 100×10⁴ (e.g., 30×10⁴ to 70×10⁴) can bring about better results. In this specification, the values of Mw are ones obtained through GPC (gel permeation chromatography) and calculated for standard polystyrene.

The pressure-sensitive adhesive composition in the techniques disclosed herein can be a composition which contains a tackifier resin. The tackifier resin is not particularly limited, and use can be made of various tackifier resins including, for example, rosin-based resins, terpene-based resins, hydrocarbon-based resins, epoxy resins, polyamide-based resins, elastomer-based resins, phenolic resins, and ketone-based resins. One of such tackifier resins can be used alone, or two or more thereof can be used in combination.

Examples of the rosin-based tackifier resins include: unmodified rosins (crude rosins) such as gum rosin, wood rosin, and tall oil rosin; modified rosins (hydrogenated rosins, disproportionated rosins, polymerized rosins, and other chemically modified rosins) obtained by modifying those unmodified rosins by hydrogenation, disproportionation, polymerization, etc.; and other rosin derivatives. Examples of the rosin derivatives include: rosin esters such as ones (esterified rosins) obtained by esterifying unmodified rosins with an alcohol and ones (esterified modified rosins) obtained by esterifying modified rosins (hydrogenated rosins, disproportionated rosins, polymerized rosins, etc.) with an alcohol; unsaturated-fatty-acid-modified rosins obtained by modifying unmodified rosins or modified rosins (hydrogenated rosins, disproportionated rosins, polymerized rosins, etc.) with an unsaturated fatty acid; unsaturated-fatty-acid-modified rosin esters obtained by modifying rosin esters with an unsaturated fatty acid; rosin alcohols obtained by reducing at least some of the carboxyl groups of unmodified rosins, modified rosins (hydrogenated rosins, disproportionated rosins, polymerized rosins, etc.), unsaturated-fatty-acid-modified rosins, or unsaturated-fatty-acid-modified rosin esters; metal salts of rosins such as unmodified rosins, modified rosins, and various rosin derivatives (in particular, rosin esters); and rosin-phenol resins obtained by causing phenol to add to rosins (unmodified rosins, modified rosins, various rosin derivatives, etc.) with the aid of an acid catalyst and thermally polymerizing the addition products.

Examples of the terpene-based tackifier resins include: terpene-based resins such as α-pinene polymers, β-pinene polymers, and dipentene polymers; and modified terpene-based resins obtained by modifying these terpene-based resins (by modification with phenol, modification with an aromatic, modification by hydrogenation, modification with a hydrocarbon, etc.). Examples of the modified terpene resins include terpene-phenol resins, styrene-modified terpene-based resins, aromatic-modified terpene-based resins, and hydrogenated terpene-based resins.

Examples of the hydrocarbon-based tackifier resins include various hydrocarbon-based resins such as aliphatic-hydrocarbon resins, aromatic-hydrocarbon resins, alicyclic-hydrocarbon resins, aliphatic/aromatic petroleum resins (e.g., styrene/olefin copolymers), aliphatic/alicyclic petroleum resins, hydrogenated hydrocarbon resins, coumarone-based resins, and coumarone-indene resins. Examples of the aliphatic-hydrocarbon resins include polymers of one or more aliphatic hydrocarbons selected from among olefins and dienes which have about 4 or 5 carbon atoms. Examples of the olefins include 1-butene, isobutylene, and 1-pentene. Examples of the dienes include butadiene, 1,3-pentadiene, and isoprene. Examples of the aromatic-hydrocarbon resins include polymers of vinyl-group-containing aromatic hydrocarbons having about 8-10 carbon atoms (e.g., styrene, vinyltoluene, α-methylstyrene, indene, and methylindene). Examples of the alicyclic-hydrocarbon resins include: alicyclic-hydrocarbon-based resins obtained by subjecting a so-called “C4 petroleum fraction” or “C5 petroleum fraction” to cyclizing dimerization and then polymerizing the dimerization product; polymers of cyclodiene compounds (e.g., cyclopentadiene, dicyclopentadiene, ethylidenenorbornene, and dipentene) or products of hydrogenation of these polymers; and alicyclic-hydrocarbon-based resins obtained by hydrogenating the aromatic rings of either aromatic-hydrocarbon resins or aliphatic/aromatic petroleum resins.

In the techniques disclosed herein, a tackifier resin having a softening point (softening temperature) of about 80° C. or higher (preferably about 100° C. or higher) can be preferably used. With this tackifier resin, an adhesive sheet having higher performance (e.g., high adhesiveness) can be rendered possible. There is no particular upper limit on the softening point of the tackifier resin, and the softening point thereof can be about 200° C. or lower (typically about 180° C. or lower). The term “softening point of a tackifier resin” used herein is defined as a value measured through the softening point measuring method (ring-and-ball method) as defined in JIS K5902:1969 or JIS K2207:1996.

The amount of the tackifier resin to be used is not particularly limited, and can be suitably set in accordance with desired pressure-sensitive adhesive performance (adhesive strength, etc.). For example, it is preferred to use the tackifier resin in an amount of about 10-100 parts by mass (more preferably 15-80 parts by mass, even more preferably 20-60 parts by mass) on a solid basis per 100 parts by mass of the acrylic polymer.

A crosslinking agent may be used in the pressure-sensitive adhesive composition according to need. The kind of the crosslinking agent is not particularly limited, and use can be made of a crosslinking agent suitably selected from among known or common crosslinking agents (e.g., isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal-alkoxide-based crosslinking agents, metal-chelate-based crosslinking agents, metal-salt-based crosslinking agents, carbodiimide-based crosslinking agents, and amine-based crosslinking agents). One crosslinking agent can be used alone, or two or more crosslinking agents can be used in combination. The amount of the crosslinking agent to be used is not particularly limited, and the amount thereof can be selected, for example, from the range of up to about 10 parts by mass (for example, about 0.005-10 parts by mass, preferably about 0.01-5 parts by mass) per 100 parts by mass of the acrylic polymer.

The pressure-sensitive adhesive composition can be one which, according to need, contains various additives that are common in the field of pressure-sensitive adhesive compositions, such as leveling agents, crosslinking aids, plasticizers, softeners, fillers, colorants (pigments, dyes, etc.), antistatic agents, antioxidants, ultraviolet absorbers, oxidation inhibitors, and light stabilizers. With respect to such various additives, conventionally known ones can be used in ordinary ways. Since such additives do not especially characterize the present invention, detailed explanations thereon are omitted here.

As the volume change substance 31 to be contained in the adhesive layer 3, use can be made of microcapsules containing a phase change substance. In this embodiment, heat-expandable microcapsules are utilized as the microcapsules containing a phase change substance. The heat-expandable microcapsules are not particularly limited so long as the microcapsules expand in volume upon reception of heat supplied thereto as an external stimulus. For example, use can be made of microcapsules obtained by encapsulating a volatile organic solvent (expanding agent) such as, for example, n-butane, isobutene, n-pentane, isopentane, neopentane, n-hexane, isohexane, n-heptane and petroleum ether, with a thermoplastic resin constituted of a copolymer of vinylidene chloride, acrylonitrile, an acrylic ester, a methacrylic ester, etc. When the microcapsules are heated to or above the softening point of the membrane polymer, the membrane polymer begins to soften and, simultaneously therewith, the vapor pressure of the encapsulated expanding agent increases to swell the membranes. As a result, the microcapsule main bodies expand. In addition, the microcapsule main bodies which contain the heat-expandable material inside are configured so as to have gradually releasing properties and so that the gas evolved by the heating is gradually released from the microcapsule main bodies.

Various heat-expandable microcapsules which vary in heating mode have been developed. For example, use can be made of: microcapsules of the type in which an external heat source, e.g., a heater, is used to directly heat the microcapsules to vaporize the expanding agent present in the microcapsule main bodies to thereby expand the microcapsules; or microcapsules of the type in which a substance that absorbs far infrared radiation is contained as an expanding agent in the microcapsule main bodies and the expanding agent is heated and vaporized by irradiation with far infrared radiation to thereby expand the microcapsules.

It is also possible to use heat-expandable microcapsules of the type in which a substance having a large dielectric loss factor is contained as an expanding agent in the microcapsule main bodies and the expanding agent is heated and vaporized by irradiation with microwaves or high-frequency wave to thereby expand the microcapsules. In the case of utilizing microwaves, a substance which absorbs microwaves and has a large coefficient of dielectric loss is used as the expanding agent, the substance being, for example, water, 1-propanol, 1-butanol, 1-pentanol, ethylene glycol, 1-methyl-2-pyrrolidone, methanol, ethanol, acetone, or acetonitrile. In the case of utilizing high-frequency wave, a substance which absorbs high-frequency wave and has a large dielectric loss factor is used as the expanding agent, the substance being, for example, water, wood, phenolic resin, urea resin, cellulose, or nylon.

Furthermore usable are heat-expandable microcapsules of the type in which a magnetic substance or an electroconductive substance is contained together with an expanding agent in the microcapsule main bodies and the magnetic substance or the electroconductive substance is inductively heated with microwaves or high-frequency wave, respectively, to thereby heat and vaporize the expanding agent and expand the microcapsules. As the magnetic material, use can be made of a sintered-rare-earth magnetic material, sintered-ferrite magnetic material, bonded magnetic material, cast magnetic material, or the like. As the electroconductive substance, use can be made of iron (carbon steel, stainless steel, etc.), aluminum, copper, brass, carbon (graphite), or the like.

Moreover, use can be made of heat-expandable microcapsules of the type in which microcoils constituted mainly of either carbon atoms or carbon-containing molecules are contained together with an expanding agent in the microcapsule main bodies and the expanding agent is heated and vaporized by irradiation with electromagnetic waves to expand the microcapsules.

In the adhesive layer 3 containing such heat-expandable microcapsules, the heat-expandable microcapsules expand in volume upon heating to form a plurality of surface irregularities 6 on a surface of the adhesive layer 3. Bringing this adhesive layer 3 into contact with an adherend results in the formation of channel areas 7 (gap) for air bubble expelling based on the surface irregularities 6, between the adhesive layer 3 and the adherend. Since the heat-expandable microcapsules which have expanded in volume have gradually releasing properties, the evolved gas is gradually released outward through the microcapsule main bodies. The microcapsules thus gradually contract in volume with the lapse of time. In the case where the adhesive sheet 1 is formed so as to have, for example, a rectangular plan-view shape, it is preferred to configure the adhesive layer 3 so that the channel areas 7 communicate between the pair of opposed side-edge portions of the adhesive layer 3, from the standpoint of making the adhesive layer 3 sufficiently perform the function of expelling air bubbles.

An adhesive layer 3 containing such heat-expandable microcapsules (volume change substance 31) can be produced, for example, by dispersing the heat-expandable microcapsules in an adhesive as the main component of the adhesive layer 3 to produce a coating fluid, subsequently applying the coating fluid on one surface of a substrate 2 with a kiss coating type coating device, e.g., a micro-gravure coater, and then drying the coating fluid applied. In place of thus forming an adhesive layer 3 by directly applying a coating fluid on a substrate 2, use may be made, for example, of a method in which a sheet-shaped adhesive layer 3 that contains heat-expandable microcapsules (volume change substance 31) is formed and thereafter superposed on one surface of a substrate 2, thereby disposing the adhesive layer 3 containing the volume change substance 31 on the one surface of the substrate 2.

It is preferable that the thickness of the adhesive layer 3, which contains a volume change substance 31 and which is in the stage where the adhesive applied has been dried, is 1 μm to 300 μm. In case where the thickness thereof is less than 1 μm, there is a concern that the adhesive sheet 1 applied to an adherend might show insufficient adhesive strength.

The release liner 4 is a member which includes a liner base and a release layer (releasing coating film) and which is disposed on the adhesive layer 3 so that the release layer faces the adhesive layer 3. The release layer can be formed from, for example, a silicone-based release agent. Examples of the silicone-based release agent include thermosetting silicone-based release agents and silicone-based release agents curable with ionizing radiation. Materials usable for forming the release layer are not limited to silicone-based release agents, and a suitable one can be selected in accordance with the kind of the adhesive constituting the adhesive layer 3.

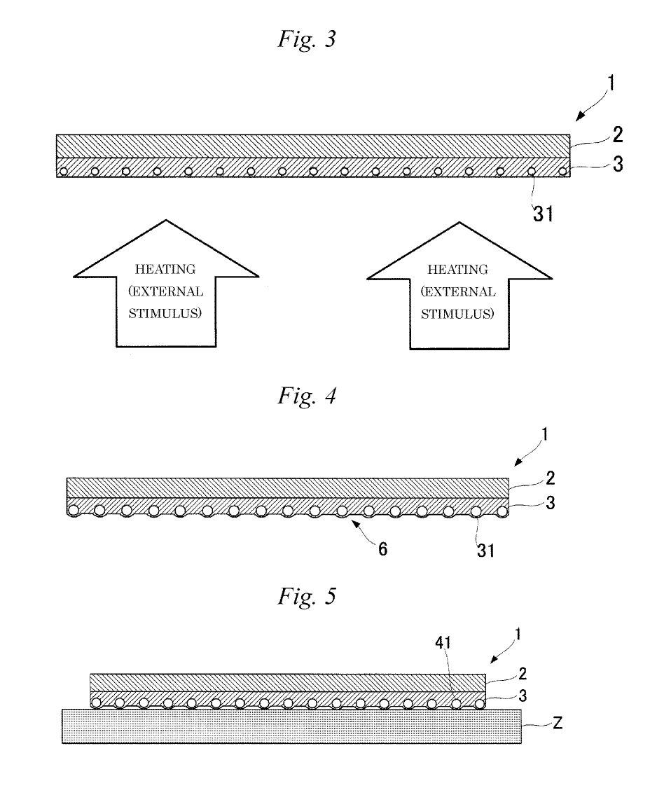

Next, while referring to FIG. 2 to FIG. 7, the adhesive-sheet application method is explained, in which the adhesive sheet 1 that has the configuration described above is applied to an adherend. First, the release liner 4 is peeled from the adhesive sheet 1 to expose one surface of the adhesive layer 3, as shown in FIG. 2. Thereafter, as shown in FIG. 3 and FIG. 4, heating of the exposed surface of the adhesive layer 3 is conducted as an external stimulus to expand the volume change substance 31 (heat-expandable microcapsules) contained in the adhesive layer 3, thereby forming surface irregularities 6 based on the volume expansion of the volume change substance 31 on the exposed surface (one surface) of the adhesive layer 3 (surface irregularity formation step). Heating as an external stimulus may be conducted without peeling the release liner 4 from the adhesive sheet 1. Furthermore, in place of heating the exposed surface of the adhesive layer 3, the whole adhesive sheet 1 may be heated.

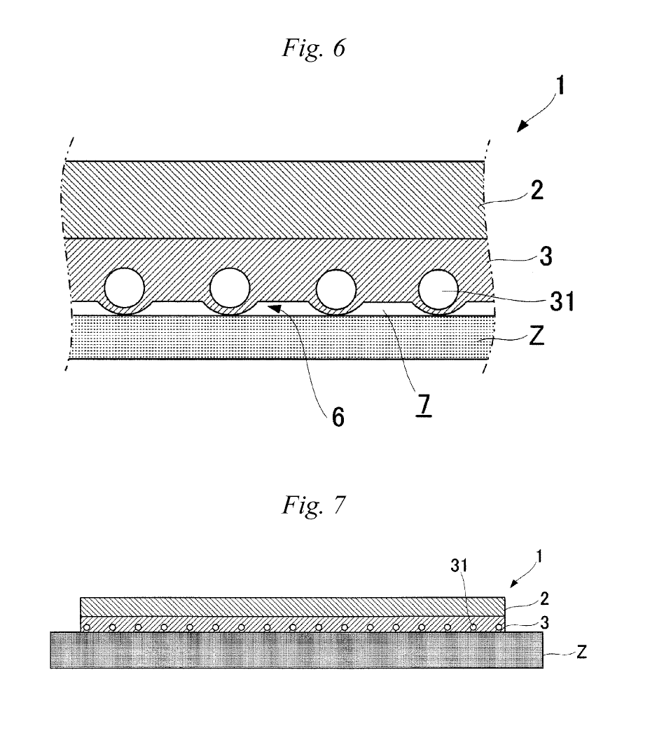

Subsequently, as shown in FIG. 5, the one surface of the adhesive layer 3 is applied to an adherend Z (application step). Upon this application, a gap (channel areas 7 for air bubble expelling) based on the surface irregularities 6 is formed between the one surface of the adhesive layer 3 and the adherend Z, as shown in the main-part enlarged view of FIG. 6. The gap (channel areas 7) functions as passages for expelling air bubbles trapped between the adhesive layer 3 and the adherend Z.

Thereafter, the gas generated in the microcapsule main bodies of the volume change substance 31 (heat-expandable microcapsules) is gradually released from the microcapsule main bodies because of the gradually releasing properties of the microcapsule main bodies, and the volume change substance 31 which has expanded in volume contracts in volume with time (with the lapse of time). The surface irregularities 6 disappear gradually with this volume contraction of the volume change substance 31, and the channel areas 7 (gap) based on the surface irregularities 6 are also diminished gradually because of the flowability of the adhesive layer 3. As the channel areas 7 are thus diminished, the air bubbles trapped (including the gas released from the microcapsules) are expelled. As a result, the area of contact between the one surface of the adhesive layer 3 and the adherend Z increases as shown in FIG. 7, and the adhesive sheet 1 comes to have improved adhesive performance including adhesive strength and repulsion resistance (adhesiveness enhancement step).

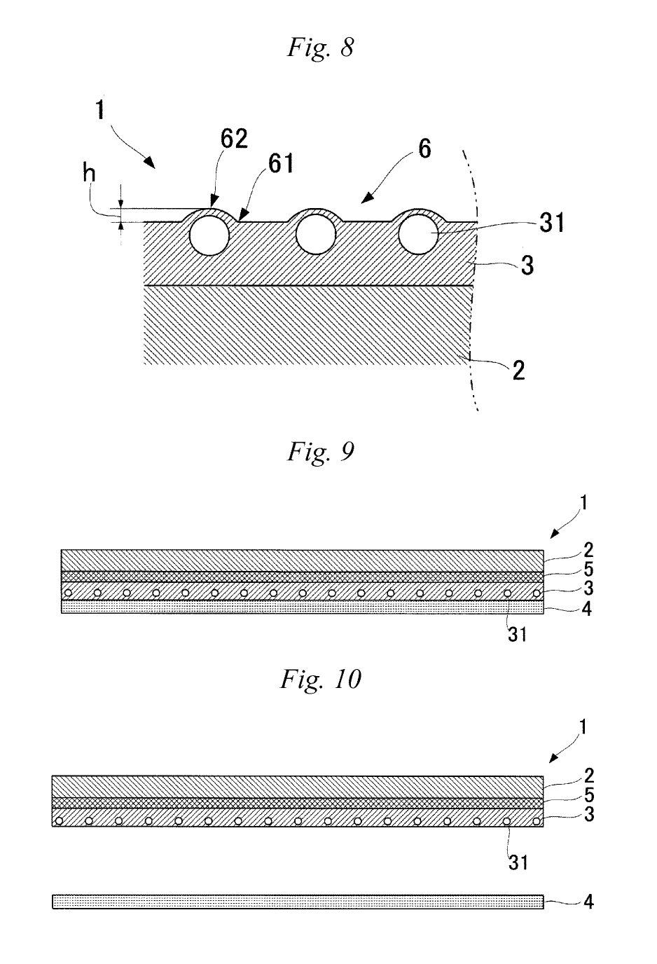

The height h of the surface irregularities 6 (height from the base 61 to the tops 62) in the adhesive layer 3 which are formed upon reception of an external stimulus, as shown in the main-part enlarged view of FIG. 8, is preferably in the range of 0.5 μm to 500 μm, more preferably in the range of 1 μm to 300 μm. In case where the height h is less than 0.5 μm, channel areas 7 for expelling the air bubbles trapped upon application to the adherend Z cannot be sufficiently ensured and there is a concern that some of the air bubbles might remain. Meanwhile, in case where the height h is larger than 500 μm, there is a concern that when the channel areas 7 gradually disappear with the volume contraction of the volume change substance 31 and due to the flow of the adhesive layer 3, some of the channel areas 7 might remain undesirably.

The average particle diameter of the volume change substance 31 (heat-expandable microcapsules in this embodiment) contained in the adhesive layer 3 is preferably in the range of 0.5 μm to 100 μm, more preferably in the range of 1 μm to 30 μm. In case where the average particle diameter thereof is less than 0.5 μm, there is a concern that it might be difficult to form channel areas 7 capable of effectively expelling trapped air bubbles. Meanwhile, in case where the average particle diameter thereof is larger than 100 μm, there is a concern that the surface irregularities 6 formed on the surface of the adhesive layer 3 might have too large a height.

In the adhesive layer 3 containing the volume change substance 31, it is preferable that the average number of particles of the volume change substance 31 per unit area (cm²) is in the range of 20 to 4×10⁸, from the standpoint of forming channel areas 7 which sufficiently perform the function of expelling air bubbles. It is more preferable that the number thereof is in the range of 100 to 1×10⁵. In case where the number thereof is less than 20, channel areas 7 for expelling air bubbles trapped upon application to an adherend Z cannot be sufficiently ensured and there is a concern that some of the air bubbles might remain. Meanwhile, in case where the number thereof exceeds 4×10⁸, there is a concern that the adhesive layer 3 might come not to exhibit sufficient adhesiveness.

The maximum area of the channel areas 7 formed between the adhesive layer 3 and an adherend Z on the basis of the volume expansion of the volume change substance 31 is preferably in the range of 3-60%, more preferably in the range of 10-40%, based on the plan-view area of the adhesive layer 3.

The adhesive sheet 1 according to the first embodiment of the present invention, which has the configuration described above, is configured so that the adhesive sheet 1, just before application to an adherend Z, is in the state of being capable of reliably forming surface irregularities 6 on the surface of the adhesive layer 3. Consequently, upon application of the adhesive sheet 1 to an adherend Z, channel areas 7 for air bubble expelling can be formed without fail between the adhesive sheet 1 and the adherend Z, and the effect of expelling trapped air bubbles is extremely high.

Due to the formation of the surface irregularities 6 for air bubble expelling on the surface of the adhesive layer 3, the adhesive layer 3, immediately after application of the adhesive sheet 1 to an adherend Z, is in the state of being adherent to the adherend Z in a small contact area. Because of this, in cases when, for example, the adhesive sheet 1 has been applied in a wrong position, the adhesive sheet 1 can be easily stripped off and applied again to the adherend Z.

Furthermore, since the adhesive sheet 1 is configured so that the surface irregularities 6 formed disappear gradually with the lapse of time, the channel areas 7 (gap) formed between the adhesive layer 3 and the adherend Z disappear gradually and, hence, the area of contact between the adhesive layer 3 and the adherend Z increases. Thus, the adhesive sheet 1 can finally exhibit high adhesiveness.

Next, the adhesive sheet according to a second embodiment of the present invention is explained. FIG. 9 is a diagrammatic cross-sectional view which illustrates the configuration of the adhesive sheet according to the second embodiment of the present invention. The adhesive sheet 1 according to the second embodiment is an adhesive sheet 1 to be applied to an adherend, and includes a substrate 2, a light-shielding adhesive layer 5, an adhesive layer 3 containing a volume change substance 31, and a release liner 4 having light-shielding properties, as shown in FIG. 9.

As the substrate 2, use can be made of one which is generally used as the substrates of adhesive sheets. Specifically, use can be made of the materials shown above as examples in the explanation of the adhesive sheet 1 according to the first embodiment described above. With respect to the thickness of the substrate 2, the numerical ranges shown above as examples in the explanation of the adhesive sheet 1 according to the first embodiment described above can be employed.

The light-shielding adhesive layer 5 is disposed on one surface of the substrate 2, and has the function of preventing light from the substrate 2 side from striking on the adhesive layer 3 containing a volume change substance 31. The material to be used for forming the light-shielding adhesive layer 5 is not particularly limited so long as the material has light-shielding properties. For example, use can be made of a light-shielding adhesive composition obtained by incorporating a colorant into any of various adhesives including pressure-sensitive adhesives, thermoplastic adhesives, and thermosetting adhesives. As the colorant, it is preferred to use a black material such as iron oxide, graphite, and carbon black. In particular, carbon black is more preferred since carbon black is excellent in terms of light resistance and weatherability and exerts little influence on the adhesive properties of the light-shielding adhesive layer 5. For forming the light-shielding adhesive layer 5, a known coating technique such as roll coating, knife coating, or the like can be utilized. It is preferable that the thickness of the light-shielding adhesive layer 5 which is in the stage where the light-shielding adhesive composition applied has been dried is 1 μm to 200 μm, from the standpoint of making the light-shielding adhesive layer 5 exhibit a sufficient light-shielding effect. In cases where the substrate 2 itself has light-shielding properties, the adhesive sheet 1 may be configured without disposing the light-shielding adhesive layer 5.

The adhesive layer 3 containing a volume change substance 31 is disposed on one surface of the light-shielding adhesive layer 5. The adhesive layer 3 is configured so that a plurality of fine surface irregularities 6 are formed on the surface of the adhesive layer 3 upon reception of an external stimulus. As the adhesive serving as the main component of this adhesive layer 3, use can be made of any of the materials shown above as examples in the explanation of the adhesive sheet 1 according to the first embodiment described above. In the second embodiment, it is preferred to use a transparent adhesive because photoexpandable microcapsules are used as the volume change substance 31 as described below.

Photoexpandable microcapsules which are microcapsules containing a phase change substance is employed as the volume change substance 31 contained in the adhesive layer 3 included in the adhesive sheet 1 according to the second embodiment. The photoexpandable microcapsules are not particularly limited so long as the microcapsules expand upon irradiation with light. Examples thereof include ones in which at least one photodecomposable material selected from among azo compounds, azide compounds and tetrazole compounds is contained in microcapsule main bodies. When such microcapsules are irradiated with light as an external stimulus, the photodecomposable material decomposes by the action of the light to evolve a gas and the microcapsule main bodies hence expand. In addition, the microcapsule main bodies which contain the photodecomposable material inside are configured so as to have gradually releasing properties and so that the gas evolved by the photodecomposition is gradually released from the microcapsule main bodies.

In the adhesive layer 3 containing such photoexpandable microcapsules, the photoexpandable microcapsules expand in volume upon irradiation with light to form a plurality of surface irregularities 6 on the surface of the adhesive layer 3. Bringing this adhesive layer 3 into contact with an adherend results in the formation of channel areas 7 (gap) for air bubble expelling based on the surface irregularities 6, between the adhesive layer 3 and the adherend. Since the photoexpandable microcapsules which have expanded in volume have gradually releasing properties, the evolved gas is gradually released outward through the microcapsule main bodies. The microcapsules thus gradually contract in volume with the lapse of time. In the case where the adhesive sheet 1 is formed so as to have, for example, a rectangular plan-view shape, it is preferred to configure the adhesive layer 3 so that the channel areas 7 communicate between the pair of opposed side-edge portions of the adhesive layer 3, from the standpoint of making the adhesive layer 3 sufficiently perform the function of expelling air bubbles.

An adhesive layer 3 containing such photoexpandable microcapsules (volume change substance 31) can be produced, for example, by dispersing the photoexpandable microcapsules in an adhesive as the main component of the adhesive layer 3 to produce a coating fluid, subsequently applying the coating fluid on one surface of the light-shielding adhesive layer 5 with a kiss coating type coating device, e.g., a micro-gravure coater, and then drying the coating fluid applied. In place of thus forming an adhesive layer 3 by directly applying a coating fluid on the light-shielding adhesive layer 5, use may be made, for example, of a method in which a sheet-shaped adhesive layer 3 that contains photoexpandable microcapsules (volume change substance 31) is formed and thereafter superposed on one surface of the light-shielding adhesive layer 5, thereby disposing the adhesive layer 3 containing the volume change substance 31 on the one surface of the light-shielding adhesive layer 5.

It is preferable that the thickness of the adhesive layer 3, which contains a volume change substance 31 and which is in the stage where the adhesive applied has been dried, is 1 μm to 300 μm. In case where the thickness thereof is less than 1 μm, there is a concern that the adhesive sheet 1 applied to an adherend might show insufficient adhesive strength.

The release liner 4 is a liner having light-shielding properties as stated above, and is a sheet-shaped member disposed on one surface of the adhesive layer 3 containing a volume change substance 31. Like the light-shielding adhesive layer 5, this release liner 4 is disposed in order to isolate the adhesive layer 3 containing a volume change substance 31 from light. The release liner 4 is not particularly limited so long as the release liner 4 has light-shielding properties and has excellent releasability. For example, the release liner 4 can be constituted of either a cured sheet of a curable resin containing a colorant or a thermoplastic resin containing a colorant and having a glass transition temperature of 150° C. or higher. As the colorant, it is preferred to use a black material such as iron oxide, graphite, and carbon black, as in the light-shielding adhesive layer 5.

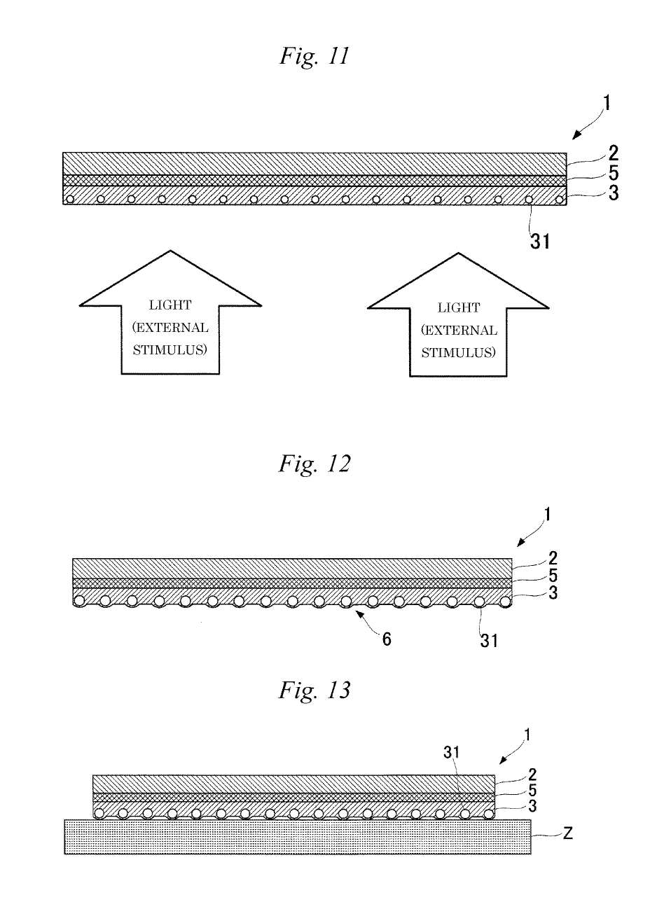

Next, while referring to FIG. 10 to FIG. 15, the adhesive-sheet application method is explained, in which the adhesive sheet 1 according to the second embodiment that has the configuration described above is applied to an adherend. First, the release liner 4 is peeled form the adhesive sheet 1 to expose one surface of the adhesive layer 3, as shown in FIG. 10. Thereafter, as shown in FIG. 11 and FIG. 12, the exposed surface of the adhesive layer 3 is subjected to irradiation with light as an external stimulus to expand the volume change substance 31 (photoexpandable microcapsules) contained in the adhesive layer 3, thereby forming surface irregularities 6 based on the volume expansion of the volume change substance 31 on the exposed surface (one surface) of the adhesive layer 3 (surface irregularity formation step).

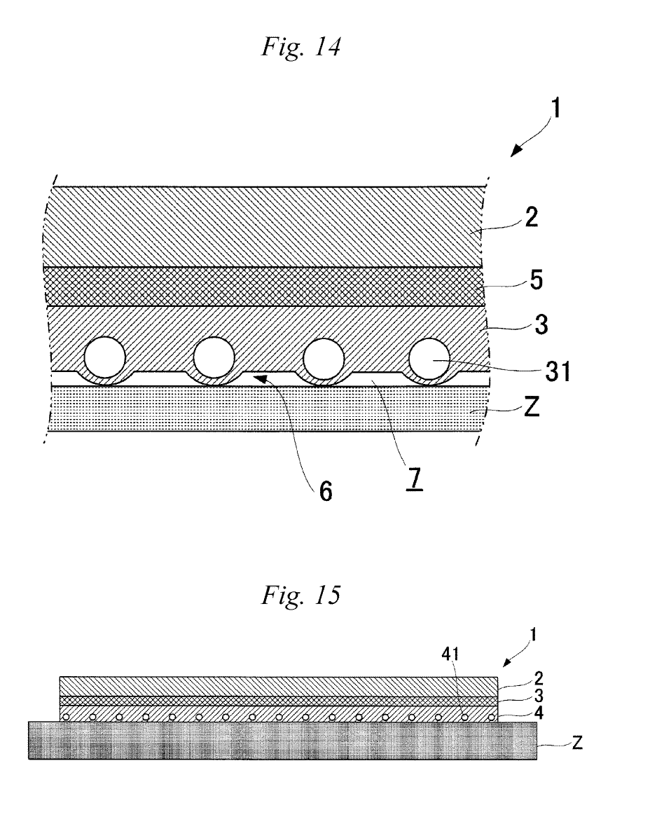

Subsequently, as shown in FIG. 13, the one surface of the adhesive layer 3 is applied to an adherend Z (application step). Upon this application, a gap (channel areas 7 for air bubble expelling) based on the surface irregularities 6 is formed between the one surface of the adhesive layer 3 and the adherend Z, as shown in the main-part enlarged view of FIG. 14. The gap (channel areas 7) functions as passages for expelling air bubbles trapped between the adhesive layer 3 and the adherend Z.

Thereafter, the gas generated in the microcapsule main bodies of the volume change substance 31 (photoexpandable microcapsules) is gradually released from the microcapsule main bodies because of the gradually releasing properties of the microcapsule main bodies, and the volume change substance 31 which has expanded in volume contracts in volume with time (with the lapse of time). The surface irregularities 6 disappear gradually with this volume contraction of the volume change substance 31, and the channel areas 7 (gap) based on the surface irregularities 6 are also diminished gradually because of the flowability of the adhesive layer 3. As the channel areas 7 are thus diminished, the air bubbles trapped (including the gas released from the microcapsules) are expelled. As a result, the area of contact between the one surface of the adhesive layer 3 and the adherend Z increases as shown in FIG. 15, and the adhesive sheet 1 comes to have improved adhesive performance including adhesive strength and repulsion resistance (adhesiveness enhancement step).

The height h of the surface irregularities 6 in the adhesive layer 3 which are formed upon irradiation with light as an external stimulus is preferably in the range of 0.5 μm to 500 μm, more preferably in the range of 1 μm to 300 μm, as in the adhesive sheet 1 according to the first embodiment. Also with respect to the average particle diameter of the photoexpandable microcapsules (volume change substance 31), the average particle diameter is preferably in the range of 0.5 μm to 100 μm, more preferably in the range of 1 μm to 30 μm, as in the adhesive sheet 1 according to the first embodiment.

In the adhesive layer 3 containing photoexpandable microcapsules, it is preferable that the average number of the photoexpandable microcapsules per unit area (cm²) is in the range of 20 to 4×10⁸, from the standpoint of forming channel areas 7 which sufficiently perform the function of expelling air bubbles. It is more preferable that the number thereof is in the range of 100 to 1×10⁵. The maximum area of the channel areas 7 formed between the adhesive layer 3 and an adherend Z based on the volume expansion of the photoexpandable microcapsules is preferably in the range of 3-60%, more preferably in the range of 10-40%, based on the plan-view area of the adhesive layer 3.

The adhesive sheet 1 according to the second embodiment of the present invention, which has the configuration described above, is configured so that the adhesive sheet 1, just before application to an adherend Z, is in the state of being capable of reliably forming surface irregularities 6 on the surface of the adhesive layer 3, like the adhesive sheet 1 according to the first embodiment. Consequently, upon application of the adhesive sheet 1 to an adherend Z, channel areas 7 for air bubble expelling can be formed without fail between the adhesive sheet 1 and the adherend Z, and the effect of expelling trapped air bubbles is extremely high.

Due to the formation of the surface irregularities 6 for air bubble expelling on the surface of the adhesive layer 3, the adhesive layer 3, immediately after application of the adhesive sheet 1 to an adherend Z, is in the state of being adherent to the adherend Z in a small contact area. Because of this, in cases when, for example, the adhesive sheet 1 has been applied in a wrong position, the adhesive sheet 1 can be easily stripped off and applied again to the adherend Z.

Furthermore, since the adhesive sheet 1 is configured so that the surface irregularities 6 formed disappear gradually at least with the lapse of time, the channel areas 7 (gap) formed between the adhesive layer 3 and the adherend Z disappear gradually and, hence, the area of contact between the adhesive layer 3 and the adherend Z increases. Thus, the adhesive sheet 1 can finally exhibit high adhesiveness.

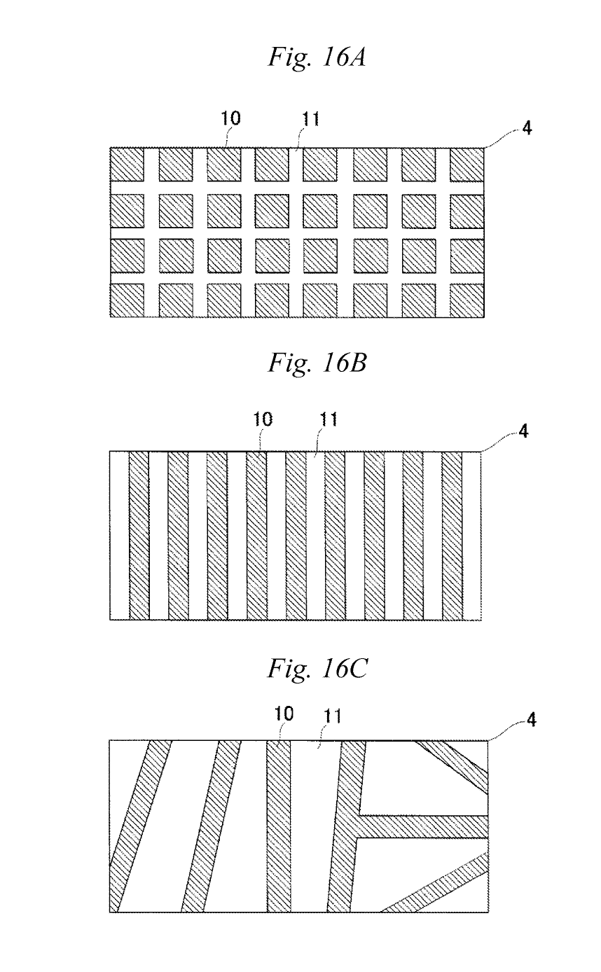

Although the adhesive sheet 1 according to the present invention has been explained above, specific configurations thereof are not limited to the embodiments described above. In each of the embodiments described above, the adhesive layer 3 is formed by dispersing a volume change substance 31 in an adhesive as the main component of the adhesive layer 3 to produce a coating fluid and applying this coating fluid, for example, on one surface of a substrate 2 or on one surface of a light-shielding adhesive layer 5. Because of this, the volume change substance 31 is dispersedly disposed approximately evenly throughout the adhesive layer 3. However, the adhesive layer 3 may be configured so that the volume change substance 31 is disposed only in a predetermined region 10, as shown in, for example, the plan views of adhesive layers 3 of FIGS. 16A to 16C. FIG. 16A shows an example in which the adhesive layer 3 is configured so that a lattice pattern is formed in one surface thereof by a region 10 where the volume change substance 31 has been disposed and a region 11 where the volume change substance 31 has not been disposed, while FIG. 16B shows an example in which a striped pattern is formed by a region 10 where the volume change substance 31 has been disposed and a region 11 where the volume change substance 31 has not been disposed. Meanwhile, FIG. 16C shows an example in which a region 10 where the volume change substance 31 has been disposed and a region 11 where the volume change substance 31 has not been disposed are randomly disposed. In these configurations, the region 11 where the volume change substance 31 has not been disposed mainly constitutes channel areas 7 for air bubble expelling. Such disposition of the volume change substance 31 only in a predetermined region 10 and such pattern arrangement of the region where the volume change substance 31 has been disposed make it possible to form channel areas 7 for air bubble expelling that are suitable for the surface shape of an adherend Z to which the adhesive sheet 1 is to be applied or that are more effective in the function of expelling air bubbles.

In the first and second embodiments described above, microcapsules containing a phase change substance were employed as the volume change substance 31, and either heat-expandable microcapsules or photoexpandable microcapsules were used as the microcapsules containing a phase change substance. However, the microcapsules containing a phase change substance are not limited to those microcapsules, and expandable microcapsules of various kinds can be utilized. For example, use can be made, for example, of expandable microcapsules which expand in volume upon reception of a shock, expandable microcapsules which expand in volume upon irradiation with an ultrasonic wave, or expandable microcapsules which expand in volume through a chemical change. In the case of configuring an adhesive sheet 1 according to the present invention using expandable microcapsules other than photoexpandable microcapsules, there is no need of disposing the light-shielding adhesive layer 5 shown in FIG. 9, etc., and the release liner 4 need not have light-shielding properties.

The expandable microcapsules which expand in volume upon reception of a shock are microcapsules which expand in volume upon reception of a shock (e.g., impact or friction) as an external stimulus. For example, such microcapsules can be configured of microcapsule main bodies and an azide compound contained therein. Since the azide compound readily decomposes upon reception of a shock such as an impact and friction to emit nitrogen gas, the microcapsules are expanded in volume by the nitrogen gas.

The expandable microcapsules which expand in volume upon irradiation with an ultrasonic wave are, for example, microcapsules which include gas-saturated water contained as an expanding agent in the microcapsule main bodies and in which microbubbles are generated by irradiation with an ultrasonic wave as an external stimulus to expand the microcapsules in volume. Examples of the gas to be dissolved in water to saturation include fluorocarbons, sulfur hexafluoride, air bubbles, oxygen, nitrogen, carbon dioxide, rare gases, chlorine, methane, propane, butane, nitrogen monoxide, nitrous oxide and ozone.

The expandable microcapsules which expand in volume through a chemical change are, for example, microcapsules that include microcapsule main bodies which each have a double-layer structure including an inner membrane and an outer membrane and in which two substances that, when mixed with each other, evolve a gas have been respectively disposed inside the inner membrane and between the outer membrane and the inner membrane. An external stimulus such as heating and a shock is given to the microcapsules to thereby break the inner membranes to cause the two substances to chemically react with each other, thereby evolving a gas to expand the microcapsules in volume.

In the first and second embodiments described above, microcapsules containing a phase change substance were used as the volume change substance 31. However, for example, a water-absorbing member in the form of fine beads which expand in volume upon absorption of water can be utilized as a volume change substance 31. In the case where such a water-absorbing member is used as a volume change substance 31, the water-absorbing member is made to absorb water as an external stimulus, for example, by allowing the water-absorbing member to absorb atmospheric moisture or by supplying water to one surface of the adhesive layer 3 with an atomizer or the like. The water-absorbing member thus expands in volume to form surface irregularities 6 on the surface of the adhesive layer 3, and channel areas 7 (gap) for air bubble expelling which are based on the surface irregularities 6 can be formed upon application of this adhesive sheet 1 to an adherend Z. After the application of the adhesive sheet 1 to the adherend Z, the water-absorbing member dries to contract in volume. Due to this contraction and due to the flow of the adhesive layer 3, the channel areas 7 for air bubble expelling disappear gradually while expelling the trapped air bubbles. Finally, the area of contact between the adhesive layer 3 and the adherend Z increases to enhance the adhesiveness. As the material of the water-absorbing member, use can be made, for example, of a water-absorbing polymer which is a crosslinked poly(acrylic acid) copolymer or a water-absorbing polymer obtained by crosslinking a carboxymethyl cellulose salt with an epoxy compound.

Fine particles of a sublimable substance may be used as a volume change substance 31 and dispersedly disposed in the adhesive layer 3. Preferred examples of the sublimable substance include iodine. In the case of using such a sublimable substance as a volume change substance 31, heat is given as an external stimulus, thereby vaporizing the sublimable substance to form surface irregularities 6 on one surface of the adhesive layer 3. Ii is also possible to enclose a sublimable substance in microcapsule main bodies to form expandable microcapsules having sublimation properties and to configure an adhesive sheet 1 so as to include these microcapsules dispersedly disposed in the adhesive layer 3.

A stimulus-responsive gel which expands/contracts in response to heat, light, or pH (potential hydrogen) as an external stimulus may be employed as a volume change substance 31 and incorporated into an adhesive layer 3 to configure an adhesive sheet 1. In this configuration also, surface irregularities 6 can be formed on one surface of the adhesive layer 3 by giving an external stimulus such as heat, light, and pH (potential hydrogen) to the surface of the adhesive layer 3 just before application of the adhesive sheet 1 to an adherend Z. As a result, channel areas 7 for effectively expelling trapped air bubbles can be formed upon application of the adhesive sheet 1 to the adherend Z.

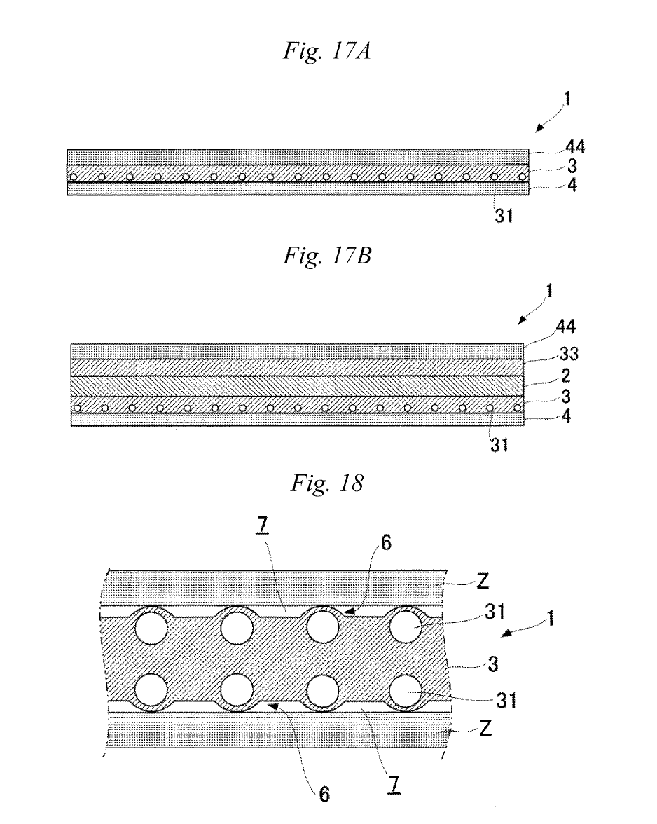

Furthermore, the adhesive sheet 1 according to each of the embodiments described above is configured as an adhesive sheet of the one-side adhesion type which includes an adhesive layer 3 formed on one surface of the substrate 2 as shown in FIG. 1 and FIG. 9 and in which an adherend Z is adhered to one-side surface of the adhesive sheet 1 as shown in FIG. 5 and FIG. 13. However, the substrate 2 in the adhesive sheet 1 is not an essential constituent element of the present invention, and the adhesive sheet 1 may be configured so as to include no substrate 2. Namely, the adhesive sheet 1 may be configured as the both-side adhesion type in which adherends are adhered respectively to both surfaces of the adhesive layer 3 so that the adhesive layer 3 is interposed therebetween. In the case of forming the adhesive sheet 1 as an adhesive sheet of such both-side adhesion type, this adhesive sheet is configured, for example, so that a release liner 4 is disposed on one surface of an adhesive layer 3 and a second release layer 44 is disposed on the other surface thereof as shown in FIG. 17A. Specific structures in the case of configuring the adhesive sheet 1 as an adhesive sheet of the both-side adhesion type are not particularly limited to the substrate-less type described above. For example, an adhesive sheet may be configured by forming an adhesive layer 3 on one surface of a substrate 2, forming a second adhesive layer 33 on the other surface thereof, and superposing release liners 4 and 44 on the exposed surfaces of the adhesive layers 3 and 33, as shown in FIG. 17B. In the case where the adhesive sheet according to the second embodiment (adhesive sheet in which the volume change substance 31 contained in the adhesive layer 3 is photoexpandable microcapsules) is configured as the both-side adhesion type, the release liner 4 and the second release liner 44 both have light-shielding properties.

Although the embodiments described above have a structure in which surface irregularities 6 capable of forming channels for expelling air bubbles are formed on one surface of an adhesive layer 3, the adhesive sheet of the present invention is not limited to ones having such a structure. For example, the adhesive sheet 1 can be configured as an adhesive sheet of the both-side adhesion type in which surface irregularities 6 capable of forming channels for expelling air bubbles are formed on each of both surfaces of an adhesive layer 3, as shown in FIG. 18.

The present application is based on Japanese Patent Application No. 2015-186180 filed on Sep. 23, 2015, the contents of which are incorporated herein by reference.

### DESCRIPTION OF REFERENCE NUMERALS AND SIGNS

1 Adhesive sheet

2 Substrate

3 Adhesive layer containing volume change substance

31 Volume change substance

4 Release liner

5 Light-shielding adhesive layer

6 Surface irregularities

7 Channel area (gap)

Z Adherend

What is claimed is:

1. An adhesive sheet which is to be applied to an adherend,
wherein the adhesive sheet comprises an adhesive layer containing a volume change substance that expands in volume upon reception of an external stimulus and thereafter contracts in volume with a lapse of time, and
the adhesive sheet is configured so that a plurality of surface irregularities are formed on at least one surface of the adhesive layer as a result of the volume expansion of the volume change substance and that channel areas for air bubble expelling are capable of being formed between said one surface of the adhesive layer and the adherend based on the surface irregularities.

2. The adhesive sheet according to claim 1, wherein the volume change substance is microcapsules containing a phase change substance.

3. The adhesive sheet according to claim 2, wherein the microcapsules containing a phase change substance are heat-expandable microcapsules or photoexpandable microcapsules.

4. The adhesive sheet according to claim 1, wherein the adhesive layer has a pair of opposed side-edge portions, and the channel areas are configured so as to communicate between the pair of opposed side-edge portions.

5. The adhesive sheet according to claim 2, wherein the adhesive layer has a pair of opposed side-edge portions, and the channel areas are configured so as to communicate between the pair of opposed side-edge portions.

6. The adhesive sheet according to claim 3, wherein the adhesive layer has a pair of opposed side-edge portions, and the channel areas are configured so as to communicate between the pair of opposed side-edge portions.

7. An adhesive-sheet application method for applying an adhesive sheet to an adherend, the method comprising:
a surface irregularity formation step in which an external stimulus is given to an adhesive sheet comprising an adhesive layer containing a volume change substance that expands in volume upon reception of an external stimulus and thereafter contracts in volume with a lapse of time, thereby causing the volume change substance to expand in volume and forming a plurality of surface irregularities on one surface of the adhesive layer;
an application step in which said one surface of the adhesive layer is applied to an adherend while forming, between said one surface of the adhesive layer and the adherend, channel areas for air bubble expelling which are based on the surface irregularities; and
an adhesiveness enhancement step in which an area of contact between said one surface of the adhesive layer and the adherend is increased while expelling air bubbles simultaneously with diminishing the channel areas which are based on the surface irregularities, at least along with volume contraction with time of the volume change substance which has expanded in volume.
